(19) United States
(12) Patent Application Publication
(10) Pub. No.: US 2009/0070189 A1
(43) Pub. Date: Mar. 12, 2009

(54) BUSINESS DOMAIN LEVEL SPECIFICATION OF A MARKETING CAMPAIGN

(75) Inventors: Howard Borenstein, Downsview (CA); Daisy Tan, Toronto (CA); Tack Tong, Scarborough (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/852,397

(22) Filed: Sep. 10, 2007

(51) Int. Cl. G06Q 30/00; G06F 17/40

(52) U.S. Cl. 705/10

(57) ABSTRACT

Embodiments of the present invention address deficiencies of the art in respect to the customer experience marketing component of an e-commerce system and provide a novel and non-obvious method, system and computer program product for specifying marketing campaigns in an e-commerce system at a business domain level. In one embodiment of the invention, a method for specifying marketing campaigns in an e-commerce system at a business domain level can include specifying criteria for triggering a marketing campaign for a specific customer through a form based user interface, generating monitoring criteria for monitoring customer behavior for the specific customer from the specified criteria, monitoring customer behavior according to the monitoring criteria, and triggering a marketing campaign for the specific customer only when observing customer behavior consistent with the monitoring criteria when monitoring the customer behavior.

### BACKGROUND OF THE INVENTION

1. Field of the Invention

The present invention relates to the field of e-commerce driven marketing and more particularly to customer behavior responsive marketing in an e-commerce system.

2. Description of the Related Art

E-commerce systems have evolved to provide virtual storefronts whose operational capabilities far exceed those of the traditional, brick and mortar store. Whereas in the brick and mortar store, each of the sales, marketing, order fulfillment, inventory, and customer service functions remain the separate responsibilities of corresponding business roles, in a well-defined e-commerce system, each of the sales, marketing, order fulfillment, inventory and customer service can be integrated in a single computing system in a highly automated fashion. Consequently, a more optimal business operation can result in which data flows between different functional subsystems seamlessly to facilitate the daily conduct of business managed by the e-commerce system.

In the prototypical e-commerce system, an on-line catalog of available goods and/or services for sale can be established along with associated pricing. Customers can be provided with a store front user interface through which customers can browse the on-line catalog. When a customer desires to purchase a product or service, the customer can so indicate causing the addition of the selected product or service to an on-line shopping cart, though it is also known to bypass the shopping cart model in favor of direct purchase model.

Like the brick and mortar model, in e-commerce a virtual shopkeeper must improve and refine offered products and services to continuously satisfy the needs and desires of customers in order to win customer loyalty. Yet, as in the case of the brick and mortar model, competing on the quality and nature of goods and services alone is not enough to win and keep customers. Rather, the virtual shopkeeper must engage and enrich on-line customers by providing favorable touch points throughout the on-line purchase experience cycle.

One aspect of providing a favorable customer experience includes presenting personalized content through the on-line store interface based upon historically observed customer behavior embodied within a customer profile. For example, personalized content can include products of certain interest to the particular customer, or pop-up incentives to purchase products of certain interest to the particular customer. In most e-commerce systems, customer profile data remains relatively static even though customer behavior is known to be fairly dynamic. Consequently, analytics systems can capture customer behavior in order to tune a corresponding customer profile. Unfortunately, though, analytics systems do not produce relevant profile data in real time.

To address the static nature of customer profile generation and maintenance, the customer experience marketing component of an e-commerce system captures all customer behavior albeit at great computing resource expense. Additionally, the customer experience marketing component of an e-commerce system seldom if ever knows whether or not observed customer behavior will be used to select personalized content to be provided to a customer during an on-line session. The resource demanding nature of capturing customer behavior potentially can result in a performance impact to the mission critical operational transaction system. More importantly, a resulting slow response in the operational transaction system of an e-commerce system is counter-productive to the original objective of enriching customer experience.

To avoid the wasteful consumption of computing resources associated with the constant acquisition of customer behavior data, modern e-commerce systems permit the end user to program the capturing of only particular types of customer behavior arising from specific customer-store interactions. In this regard, the customer experience marketing component of an e-commerce system generally provides a programming interface through which an end user can specify with particularity a process flow resulting in a exactly what and how to capture required customer behavior. Yet, the programming interface requires a complete graphical technical specification of technical steps in terms of program logic which can be alien to the end user who may lack a computer programming background.

Accordingly, the graphical technical specification of the customer experience marketing component appears to be a programming flow chart suitable for a software engineer rather than business level tooling for a business analyst. Thus, the technical nature of the programming interface to the customer experience marketing component of the e-commerce system deters the business user from engaging with customers and providing a personalized rich customer experience throughout the purchase experience cycle. In fact, this is one of the key reasons why this type of ability is not being widely deployed in e-commerce systems.

### BRIEF SUMMARY OF THE INVENTION

Embodiments of the present invention address deficiencies of the art in respect to the customer experience marketing component of an e-commerce system and provide a novel and non-obvious method, system and computer program product for specifying marketing campaigns in an e-commerce system at a business domain level. In one embodiment of the invention, a method for specifying marketing campaigns in an e-commerce system at a business domain level can include specifying criteria for triggering a marketing campaign for a specific customer through a user interface, for example a form based user interface, generating monitoring criteria for monitoring customer behavior for the specific customer from the specified criteria, monitoring customer behavior according to the monitoring criteria, and triggering a marketing campaign for the specific customer only when observing customer behavior consistent with the monitoring criteria when monitoring the customer behavior.

In one aspect of the invention the method further can include defining the form based user interface to include both a set of customer behavior parameters to receive values through the user interface, and also text to display in association with the customer behavior parameters when prompting for values for the customer behavior parameters through the user interface. In particular, defining the user interface can include defining the form based user interface in markup to include both a set of customer behavior parameters to receive values through the form based user interface, and also text to display in association with the customer behavior parameters when prompting for values for the customer behavior parameters through the form based user interface. Finally, generating monitoring criteria can include specifying each of a product, customer behavior associated with the product and a threshold number of occurrences of the customer behavior to be observed for the specific customer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for specifying marketing campaigns in an e-commerce system at a business domain level;

FIG. 2 is a illustration of an e-commerce data processing system configured for specifying marketing campaigns in an e-commerce system at a business domain level; and,

FIG. 3 is a flow chart illustrating a process for specifying marketing campaigns in an e-commerce system at a business domain level.

### DETAILED DESCRIPTION OF THE INVENTION

Embodiments of the present invention provide a method, system and computer program product for specifying marketing campaigns in an e-commerce system at a business domain level. In accordance with an embodiment of the present invention, marketing campaign can be defined, for example through form fields in a form, to indicate a rule for triggering a marketing campaign action in response to a specified state of interaction between a target customer and the e-commerce system. Thereafter, customer behavior can be observed and compared to the rule. When the observed behavior matches the rule, the marketing campaign action can be executed. In this way, the marketing campaign action can be triggered without requiring an end user to engage in the complex programmatic specification of the customer behavior resulting in the triggering of the marketing campaign action.

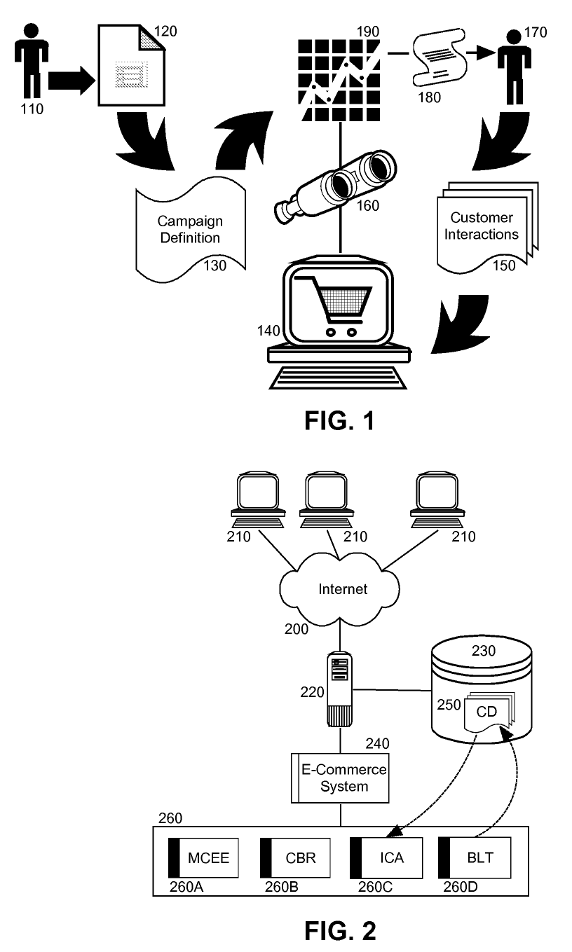

In illustration, FIG. 1 is a pictorial illustration of a process for specifying a marketing campaign in an e-commerce system at a business domain level. As shown in FIG. 1, a form 120 can be generated providing a business domain level interface for specifying a marketing campaign. An end user 110 can complete the form 120 into which different criteria can be provided to define both a customer behavior and a resulting marketing campaign to be performed when observing the behavior of a customer 170. The definition of the customer behavior and resulting marketing campaign can be placed in a campaign definition 130 and provided to a customer behavior recorder 160 coupled to an e-commerce system 140.

The customer behavior recorder 160 can monitor customer interactions 150 by a customer 170 with the e-commerce system 140 in reference to the campaign definition for the customer 170. Also, a marketing campaign execution engine 190 can initiate a marketing campaign 180 specified by the campaign definition 130 based upon the observations of the customer behavior by the customer behavior recorder 160. In this way, business domain level parameters for initiating a marketing campaign based upon observed customer behavior can be provided in lieu of complex programming of logic monitoring customer behavior.

The process described herein can be performed within an e-commerce data processing system. In illustration, FIG. 2 pictorially depicts an e-commerce data processing system configured for specifying marketing campaigns in an e-commerce system at a business domain level. The system can include a host server 220 configured for communicative coupling to one or more clients 210 over computer communications network 200. The host server 220 can host the operation of an e-commerce system 240. The e-commerce system 240 in turn can support e-commerce interactions with customers through the clients 210, including product browsing and purchasing interactions.

A business domain level marketing campaign specification and execution system 260 can be coupled to the e-commerce system 240. The business domain level marketing campaign specification and execution system 260 can include a marketing campaign execution engine 260A configured to execute marketing campaigns interacting with corresponding customers interacting with the e-commerce system 240 according to one or more defined marketing campaigns. The marketing campaign specification and execution system 260 also can include business level tool 260D configured to define one or more of the marketing campaigns for corresponding customers interacting with the e-commerce system 240. Each of the marketing campaigns can be derived from a selected campaign definition 250 in data store 230 coupled to host server 220. Each campaign definition 250 can include a specification of a customer behavior in terms of behavior parameters and a form based interface for acquiring values for the parameters.

For example, a campaign definition 250 can be defined in markup as follows:

```
<definition=“product_browsed”>
      <customer_behavior>
            <type>browse_product</type>
            <variables>
                  <variable id=“product”>
                        <type>string</type>
                  <variable>
                  <variable id=“times”>
                        <type>integer</type>
                  <variable>
                  <variable id=“last_days”>
                        <type>integer</type>
                  <variable>
            </variables>
      </customer_behavior>
      <display>
            <string>
                  <text>Customer browsed product</text>
                  <variable refid=“product” />
                  <variable refid=“times” />
                  <text>times in the last</text>
                  <variable refid=“last_days” />
                  <text>days</text>
            </string>
      </display>
      <evaluation>
            <customer_behavior_analysis>
                  <customer_behavior>
                        <type>browse_product</type>
                        <variables>
                            <variable
                            refid=“product”>product</variable>
                        </variables>
                  </customer_behavior>
                  <occurrence refid=“times” />
                  <date_range>
                        <type refid=“last_days”>prior</type>
                  </date_range>
            </customer_behavior_analysis>
      </evaluation>
</definition>
```

The resulting values received for a campaign definition through the business level tool 260D can be persisted in a specific campaign response to a specific customer behavior, referred to as a targeter. In this regard, based upon the exemplary campaign definition, the business level tool 260D can display a form as “Customer browsed product [BLANK][BLANK] times in the last [BLANK] days. The blanks can be completed for a specific customer as values and transformed into a targeter for the specific customer. An exemplary targeter can include, for instance:

```
<targeter id=“1” refid=“product_browsed”>
        <values>
              <value refid=“product”>productname</value>
              <value refid=“times”>numericvalue</value>
              <value refid=“last_days”>numericvalue</value>
        </values>
</targeter>
```

where the productname is a name of a product and each numericvalue is an integer, collectively reflecting a number of times the customer associated with customer identifier 1 has browsed the specific product over the past number of days, respectively.

The targeter, in turn, can be passed to an intelligent campaign analyzer 260C. The intelligent campaign analyzer 260C can be configured to process each targeter to manage a customer behavior recorder 260B. The customer behavior recorder 260B can include a specification of a particular customer behavior for a particular customer set forth in the targeter and a set of values for parameters for the customer behavior set forth in the targeter responsive to which a trigger can be invoked in a marketing campaign execution engine 260A.

An exemplary customer behavior recorder 260B includes,

```
<customer_behavior_recorder id=“101” targeter_refid=“1”>
      <customer_behavior>
            <type>browse_product</type>
            <variables>
                  <variable id=“product”>coffee mug</variable>
            </variables>
      </customer_behavior>
</customer_behavior_recorder>
<customer_behavior_evaluator refid=“101” targeter_refid=“1”>
      <true>
            <occurrence>3</occurrence>
            <date_range>
                  <type>prior</type>
                  <value>7</value>
            </date-range>
      </true>
</customer_behavior_evaluator>
```

in which the customer_behavior portion specifies which behavior to record for a specified customer and in which the customer_behavior evaluator specifies how to evaluate the targeter.

Notably, the intelligent campaign analyzer 260C further can append to the customer behavior recorder 260B a reference to evaluator program logic to evaluate the customer_behavior_evaluator based upon the customer identifier and reference identifier for the monitored customer behavior. Thereafter, upon receiving a trigger from the customer behavior recorder 260B, the marketing campaign execution engine 260A can invoke a marketing campaign to be applied to the customer associated with the customer behavior recorder 260B.

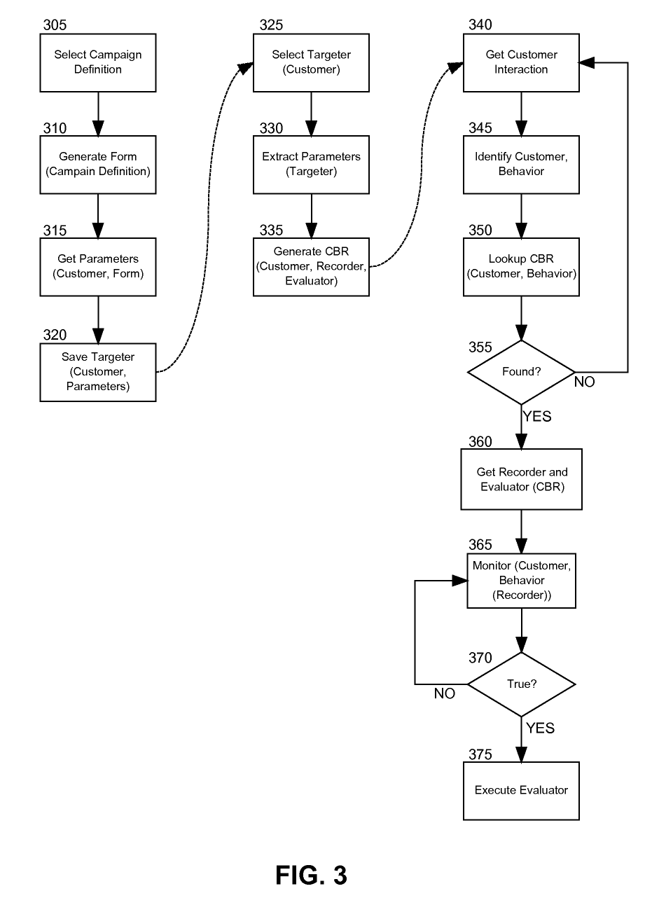

In yet further illustration, FIG. 3 is a flow chart illustrating a process for specifying marketing campaigns in an e-commerce system at a business domain level. Beginning in block 305, a campaign definition can be selected for processing and in block 310, a user interface form can be generated from the campaign definition to collect parameter values for a particular customer and customer behavior. In block 315, the parameter values for a particular customer and customer behavior can be received through the form and in block 320, a targeter can be produced for the customer and customer behavior.

In block 325, a targeter can be selected for processing for a specified customer. In block 330, the parameter values can be extracted from the targeter in order to generate a customer behavior recorder in block 335. In particular, the customer behavior recorder can identify a specific customer, a specific behavior and an evaluator to determine whether or not to trigger a marketing campaign for the customer in response to the observation of the customer behavior. Thereafter, in block 340, a customer interaction can be observed and in block 345, the customer interaction can be interpreted as a known customer behavior.

In block 350, the customer behavior and the interacting customer can be determined and a customer behavior recorder can be located based upon the customer behavior and the identity of the interacting customer. In decision block 355, if a customer behavior recorder can be located for the customer and corresponding customer behavior, in block 360, the behavior recorder can be extracted to determine the threshold for observing the specified customer behavior and the evaluator can be extracted to determine whether or not the threshold behavior has been observed. In block 365, the customer can be monitored to determine whether or not the threshold behavior has been observed. In decision block 370, if the evaluator evaluates to true, in block 375 an associated marketing campaign can be launched for the customer.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for specifying marketing campaigns in an e-commerce system at a business domain level, the method comprising:
specifying criteria for triggering a marketing campaign for a specific customer through a form based user interface;
generating monitoring criteria for monitoring customer behavior for the specific customer from the specified criteria;
monitoring customer behavior according to the monitoring criteria; and,
triggering a marketing campaign for the specific customer only when observing customer behavior consistent with the monitoring criteria when monitoring the customer behavior.

2. The method of claim 1, further comprising defining the form based user interface to include both a set of customer behavior parameters to receive values through the form based user interface, and also text to display in association with the customer behavior parameters when prompting for values for the customer behavior parameters through the form based user interface.

3. The method of claim 2, wherein defining the form based user interface to include both a set of customer behavior parameters to receive values through the form based user interface, and also text to display in association with the customer behavior parameters when prompting for values for the customer behavior parameters through the form based user interface, comprises defining the form based user interface in markup to include both a set of customer behavior parameters to receive values through the form based user interface, and also text to display in association with the customer behavior parameters when prompting for values for the customer behavior parameters through the form based user interface.

4. The method of claim 1, wherein generating monitoring criteria for monitoring customer behavior for the specific customer from the specified criteria, comprises specifying each of a product, customer behavior associated with the product and a threshold number of occurrences of the customer behavior to be observed for the specific customer.

5. An e-commerce data processing system comprising:
a plurality of campaign definitions, each specifying both a set of customer behavior parameters to receive values through a form based user interface, and also text to display in association with the customer behavior parameters when prompting for values for the customer behavior parameters through the form based user interface;
a business level tool configured to process individual ones of the campaign definitions for corresponding customers to present a form based user interface through values for customer behavior parameters are received and to generate targeters for corresponding ones of the customers;
an intelligent campaign analyzer configured to analyze different ones of the targeters to produce associated customer behavior recorders; and,
a marketing and campaign execution engine configured to monitor customer behavior for different ones of the customers according to corresponding ones of the customer behavior recorders and for each of the customers, to trigger a marketing campaign when a customer behavior specified in an associated one of the customer behavior recorders is observed.

6. The system of claim 5, wherein each of the campaign definitions is specified in markup.

7. A computer program product comprising a computer usable medium embodying computer usable program code for specifying marketing campaigns in an e-commerce system at a business domain level, the computer program product comprising:
computer usable program code for specifying criteria for triggering a marketing campaign for a specific customer through a form based user interface;
computer usable program code for generating monitoring criteria for monitoring customer behavior for the specific customer from the specified criteria;
computer usable program code for monitoring customer behavior according to the monitoring criteria; and,
computer usable program code for triggering a marketing campaign for the specific customer only when observing customer behavior consistent with the monitoring criteria when monitoring the customer behavior.

8. The computer program product of claim 7, further comprising computer usable program code for defining the form based user interface to include both a set of customer behavior parameters to receive values through the form based user interface, and also text to display in association with the customer behavior parameters when prompting for values for the customer behavior parameters through the form based user interface.

9. The computer program product of claim 8, wherein the computer usable program code for defining the form based user interface to include both a set of customer behavior parameters to receive values through the form based user interface, and also text to display in association with the customer behavior parameters when prompting for values for the customer behavior parameters through the form based user interface, comprises computer usable program code for defining the form based user interface in markup to include both a set of customer behavior parameters to receive values through the form based user interface, and also text to display in association with the customer behavior parameters when prompting for values for the customer behavior parameters through the form based user interface.

10. The computer usable program code of claim 8, wherein the computer usable program code for generating monitoring criteria for monitoring customer behavior for the specific customer from the specified criteria, comprises computer usable program code for specifying each of a product, customer behavior associated with the product and a threshold number of occurrences of the customer behavior to be observed for the specific customer.
